(19) United States
(12) Patent Application Publication
(10) Pub. No.: US 2017/0289082 A1
(43) Pub. Date: Oct. 5, 2017

(54) METHOD AND DEVICE FOR IDENTIFYING SPAM MAIL

(71) Applicant: ALIBABA GROUP HOLDING LIMITED, George Town (KY)

(72) Inventor: Chaoyang SHEN, Beijing (CN)

(73) Assignee: ALIBABA GROUP HOLDING LIMITED

(21) Appl. No.: 15/474,967

(22) Filed: Mar. 30, 2017

(30) Foreign Application Priority Data
Mar. 31, 2016 (CN) CN 201610202020.6

(51) Int. Cl. H04L 12/58

(52) U.S. Cl. CPC H04L 51/12; H04L 51/22

(57) ABSTRACT

A method and a device for identifying spam mail are provided. The method for identifying spam mail may include extracting a mail feature of an e-mail to be identified, the mail feature indicating a feature having a stability characteristic extracted from the e-mail; generating feature string information from the mail feature, and generating a mail fingerprint from the feature string information by a preset fingerprint generating method; comparing the generated mail fingerprint with an existing fingerprint in a preset mail fingerprint set, when the mail fingerprint is matched with the existing fingerprint, increasing a count of e-mails having the mail fingerprint; determining whether the count of e-mails having the mail fingerprint is greater than or equal to a preset threshold; determining the e-mail to be identified as a spam mail, if the count of e-mails having the mail fingerprint is greater than or equal to a preset threshold.

### CROSS REFERENCE TO RELATED APPLICATION

The disclosure is based on and claims the benefits of priority to Chinese Application No. 201610202020.6, filed Mar. 31, 2016, the entire contents of which are incorporated herein by reference.

### TECHNICAL FIELD

The disclosure relates to the technical field of identifying spam mail, and in particular, to a method and a device for identifying spam mail. The disclosure further relates to a mail fingerprint generating method and device for identifying spam mail.

### BACKGROUND

With the development of network technologies, the network environment has been damaged severely. For example, a spam mail is one of the reasons for damaging the network environment. The spam mail seriously affects the user experience for using e-mail, and may even cause serious loss to users.

One common spam-sending behavior to send a number of mail with similar contents to different mail recipients. Therefore, a commonly-used spam-mail identifying strategy is to identify and count the number of similar mail of a same type received within a period of time. If the number exceeds a specified threshold, it is determined that there is a suspicion of mass spam mailing.

However, there are problems with the above identifying strategy. A main problem lies in: even if the content of the mail is similar, if a certain change exists in text character strings of the mail, mail fingerprints generated by the strategy may vary significantly. Thus, similar spam mail classified into the same type cannot be counted, and whether the mail is spam mail cannot be judged by the generated mail fingerprints.

Unfortunately, in reality, many spammers intentionally add a number of interference information to the mail text, or write more spam mail that is similar in content but differ greatly in text, thus bypassing an anti-spam system. Therefore, regarding the forgoing problems, generally, it is difficult to identify spam mail. On the other hand, it also indicates the current spam mail identifying method is not efficient.

### SUMMARY

Embodiments of the disclosure provide a method for identifying spam mail may, including: extracting a mail feature of an e-mail to be identified, the mail feature indicating a feature having a stability characteristic extracted from the e-mail; generating feature string information from the mail feature, and generating a mail fingerprint from the feature string information by a preset fingerprint generating method; comparing the generated mail fingerprint with an existing fingerprint in a preset mail fingerprint set, when the mail fingerprint is matched with the existing fingerprint, increasing a count of e-mails having the mail fingerprint; and determining whether the count of e-mails having the mail fingerprint is greater than or equal to a preset threshold; determining the e-mail to be identified as spam mail, if the count of e-mails having the mail fingerprint is greater than or equal to a preset threshold.

Embodiments of the disclosure further provide a device for identifying spam mail, including: a mail feature extracting unit, configured to extract a mail feature of an e-mail to be identified, the mail feature indicating a feature having a stability characteristic extracted from the e-mail; a mail fingerprint generating unit, configured to generate feature string information from the mail feature, and generate a mail fingerprint from the feature string information by a preset fingerprint generating method; a fingerprint comparing unit, configured to compare the generated mail fingerprint with an existing fingerprint in a preset mail fingerprint set, and increase a count of e-mails having the mail fingerprint, when the mail fingerprint is matched with the existing fingerprint; a determining unit, configured to determine whether the count of e-mails having the mail fingerprint is greater than or equal to a preset threshold; and a spam mail determining unit, configured to determine the e-mail to be identified as spam mail, if the count of e-mails having the mail fingerprint is greater than or equal to a preset threshold.

Embodiments of the disclosure further provide a mail fingerprint generating method for identifying spam mail, comprising: extracting a mail feature of an e-mail to be identified, the mail feature indicating a feature having a stability characteristic extracted from the e-mail; and generating feature string information from the mail feature, and generating a mail fingerprint from the feature string information by a preset fingerprint generation method.

Embodiments of the disclosure further provide a mail fingerprint generating device for identifying spam mail, comprising: a mail feature extracting unit, configured to extract a mail feature of an e-mail to be identified, the mail feature comprising a mail subject feature, a mail morphology feature, and/or a suspected spam mail feature; and a mail fingerprint generating unit, configured to generate feature string information from the mail feature, and generate a mail fingerprint from the feature string information by a preset fingerprint generation method.

Embodiments of the disclosure may have the following advantages.

The method for identifying spam mail provided by the embodiments of the disclosure includes: extracting a mail feature of an e-mail to be identified, the mail feature indicating a feature of a stability characteristic extracted from the e-mail; generating feature string information from the mail feature; generating a mail fingerprint from the feature string information by a preset fingerprint generating method; comparing the generated mail fingerprint with an existing fingerprint in a preset mail fingerprint set; when the mail fingerprint is matched with the existing fingerprint, increasing a count of e-mails having the mail fingerprint; determining whether the count of e-mails having the mail fingerprint is greater than or equals to a preset threshold; if yes, the e-mail to be identified being spam mail.

The method is not only based on the mail text, but also forms feature string information based on an extracted relatively stable mail feature (which can include a subject feature, a mail morphology feature, a suspected spam mail feature and the like), and uses the feature string information as an input of a preset fingerprint generating method to generate a mail fingerprint.

Further, by using such mail fingerprint, a similar mail having a mail fingerprint matched with an existing fingerprint, will be determined from the existing mail fingerprint set. And whether the e-mail to be identified is suspected of being a mass spam mail will be determined by the count of the similar mail. Therefore, identifying the spam mail with such a method can better identify and capture the spam mail of the same type whose mail texts continuously change but have similar contents, thus improving the accuracy for identifying spam mail.

### BRIEF DESCRIPTION OF THE DRAWINGS

The drawings herein are provided, as a part of the disclosure, for further understanding of the disclosure. Illustrative embodiments of the disclosure and description thereof are used to explain the disclosure, and are not restrictive. In the drawings,

FIG. 1 is a flow chart of a method for identifying spam mail according to embodiments of the disclosure;

FIG. 2 is a flow chart of another method for identifying spam mail according to embodiments of the disclosure;

FIG. 3 is a structural schematic diagram of a device for identifying spam mail according to embodiments of the disclosure;

FIG. 4 is a flow chart of a mail finger print generating method for identifying spam mail according to embodiments of the disclosure; and

FIG. 5 is a structural schematic diagram of a mail fingerprint generating device for identifying spam mail according to embodiments of the disclosure.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

The objects, features, and characteristics of the disclosure, as well as the methods of operation and functions of the related elements of structure and the combination of parts and economies of manufacture, may become more apparent upon consideration of the following description with reference to the accompanying drawing(s), all of which form a part of this specification. It is to be expressly understood, however, that the drawing(s) are for the purpose of illustration and description only and are not intended as a definition of the limits of the invention. As used in the specification and in the claims, the singular form of “a”, “an”, and “the” include plural referents unless the context clearly dictates otherwise.

Embodiments of the disclosure provide a method for identifying spam mail. The method collects some relatively stable features in an e-mail to be identified; combines the collected stable features into a mail fingerprint according to a preset fingerprint generating method; determines a mail similarity according to the mail fingerprint; and further identifies whether the e-mail to be identified is spam mail.

The method is not only based on unstable mail text features, but also determines whether the e-mail to be identified is spam mail by analyzing all of the collected stable features.

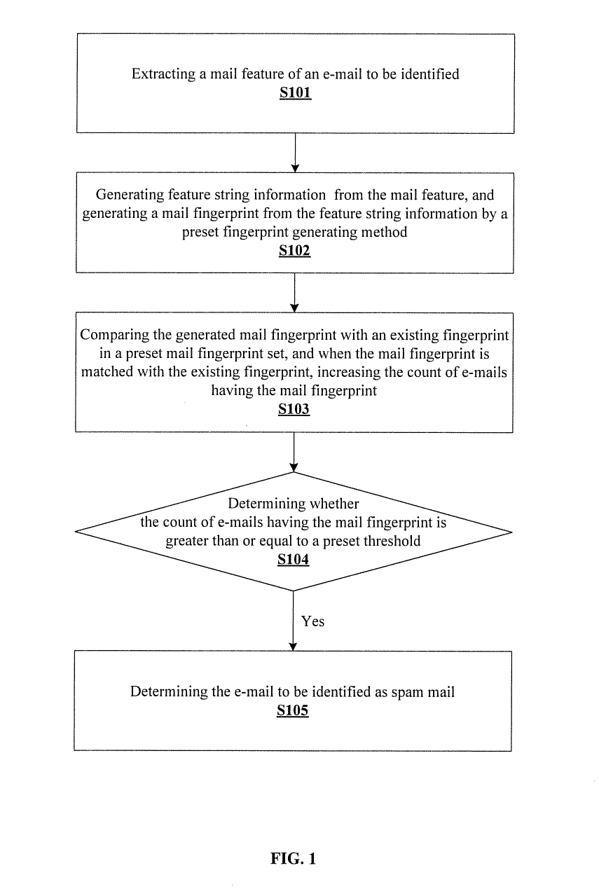

The method is illustrated and described below through embodiments as below. FIG. 1 is a flow chart of an exemplary method for identifying spam mail according to embodiments of the disclosure. As shown in FIG. 1, the method for identifying spam mail may include the following steps.

In step S101, a mail feature of an e-mail to be identified may be extracted. The mail feature indicates a feature having a stability characteristic extracted from the e-mail. For example, the mail feature may include a type of the e-mail, a replied mail address, and attachment information. The mail feature will be further described as below.

The mail feature may include: a mail subject feature, a mail morphology feature and/or a suspected spam mail feature.

The mail feature is a relatively stable feature extracted from the mail. The mail feature may also reflect characteristics or attributes of the e-mail to a greater extent. The method mainly processes the mail feature, which may even be defined as an original basis for determining whether the e-mail to be identified is spam mail.

However, before the mail feature is extracted, in some embodiments, it the e-mail to be identified can be parsed.

By parsing the e-mail, purpose-indicating information can be obtained. Purpose-indicating information can be used to identify emails that include spam information. If the e-mail is in a Multipurpose Internet Mail Extensions (MIME) format, the method for parsing the e-mail may parse by a MIME decoding. The MIME decoding of the e-mail may include acquiring the content in respective domains of the MIME, and selecting the content that is useful for classifying e-mails and the like. Therefore, the obtained purpose-indicating information may include remaining information that indicates the characteristics and actual content of the e-mail after removing less important information (such as information added during sending or receiving the e-mail).

After the e-mail to be identified is parsed, extracting a mail feature of an e-mail to be identified may include extracting the mail feature from the e-mail.

In addition, the e-mail may also be parsed in other manners or methods. Therefore, the parsing is not only limited to the MIME decoding. Any other method for decoding the e-mail may fall within the scope of the disclosure.

The embodiments of the disclosure utilize the extracted mail feature. The mail feature includes: a mail subject feature, a mail morphology feature, and a suspected spam mail feature. Extracting the above features in the mail feature will be respectively illustrated and described in detail as below.

The following mainly describes extracting a mail subject feature in the mail feature.

When the mail feature includes the mail subject feature, extracting a mail feature of an e-mail to be identified includes extracting the mail subject feature of the e-mail to be identified.

The mail subject feature is acquired by:

acquiring mail classification information in the mail subject feature;

acquiring trigger action information in the mail subject feature, the trigger action information indicating information regarding an action to be further made; and

acquiring attachment information in the mail subject feature.

Therefore, it should be noted that, the mail subject feature actually includes the following three pieces of information: mail classification information, trigger action information and attachment information. The mail subject feature may include the above three pieces of information, or may be a combination of any two pieces of information, or any one piece of the information.

However, results of determining will be more accurate based on more information or features, as a basis for determining will be more stable. Therefore, in some embodiments, the mail subject feature may include the above three pieces of information at the same time.

Methods for acquiring the above three pieces of information will be described as below, respectively.

Mail classification information in the mail subject feature may be acquired first. The mail classification information includes category information classified according to content types of the spam mail. For example, according to the content types, the common spam mail may be classified as: an invoice type, a dating type, a training course type and the like. The mail classification information indicates whether the content type of the e-mail belongs to any of the common classifications of the spam mail.

In some embodiments, the mail classification information is acquired by: acquiring a mail content type of the e-mail to be identified by a preset text classifier, and using the mail content type as the mail classification information in the mail subject feature.

The text classifier is a classifier that identifies the text type for text in the mail according to the feature of the text. The mail content type of the e-mail can be identified by the text classifier. Thus, the type of the e-mail can be used as the mail classification information. It should be noted that, mail and e-mails described in embodiments of the disclosure may be used interchangeably.

In this embodiment, a brief description may be made for the text classifier. The text classifier may include: a naive Bayes text classifier, a text classifier supported by a vector algorithm or a text classifier based on a minimum approach.

The naive Bayes text classifier classifies texts according to a naive Bayes algorithm, the text classifier supported by a vector algorithm classifies texts according to the vector algorithm, and the text classifier based on a minimum approach classifies texts according to the minimum approach method. It should be noted that, the mail classification information can be obtained by any text classifier.

In addition, if the content type in the mail classification information is not in the existing content classifications, a training for new classifications can be performed in other manners, which will be described as below.

If a certain text does not belong to any known classification, a core text (e.g., a core word extracted through a term frequency—inverse document frequency (TF-IDF) method) is directly extracted as current classification information.

Generally, although spam mail keeps coming, common content types of the spam mail are relatively stable. Thus, generally, no new type is added by acquiring a core text and conducting off-line trainings.

How to extract mail classification information in the mail subject feature has been described above, as a part of acquiring the mail subject feature. The trigger action information in the mail subject feature will be described as below.

The trigger action information in the step of acquiring trigger action information in the mail subject feature includes: a replied mail address, a phone number, a contact for a social software, bank card information, company information and/or a webpage link symbol.

The trigger action information indicates related information that the mail sender wants the recipient to perform subsequent actions on. The sender sets the trigger action information in the mail to guide the recipient to reply to the related information. The sender can then receive the related information on the recipient. In general, the trigger action information may include information (an e-mail address, a phone number, a QQ™ number, a bank card number, a company name and the like) that allows the recipient to reply to the sender.

The trigger action information is generally acquired or extracted by a preset mode matching method.

In some embodiments, the mode matching method is generally a regular expression method. A regular expression uses a single character string to describe and match a series of character strings in line with a certain syntactic rule. In a text editor, the regular expression is always used to retrieve and replace the text that matches with a certain mode.

In some embodiments, some phone numbers may be matched and extracted by the regular expression. For example, an expression as “\b\d{3,4}−\d{7,8} \b” can be set to match with a phone number in text, such as 010-12345678.

In the above step, according to a rule set in the regular expression, some text features corresponding to the rule are extracted. Thus, the trigger action information can be extracted and obtained through the regular expression.

In addition, the trigger action information further includes a webpage link symbol. That is, a Uniform Resource Locator (URL) link. For the URL link, webpage link symbol information corresponding thereto may be acquired with different methods according to different lengths of the website address corresponding to the link.

In some embodiments, it is determined whether a website address corresponding to the webpage link symbol is a full website address. If so, a parameter part in the website address is removed, and a new formed website address is recorded in a retained set of website addresses.

When the result of determining whether a website corresponding to the webpage link symbol is a full website address is no, it may further determine whether the website address is a short website address.

When the website address is a short website address, a new website address formed by retaining a domain name part of the website address is recorded in the retained website address set.

Website addresses in the retained website address set are matched with a preset white list, and website addresses having the same information as in the white list in the retained website address set are removed, so as to form a new retained website address set.

The new retained website address set is used as an additional webpage link symbol. That is, if the website address is a short website address, only the domain name part is retained. And if the website address is a full website address, generally, a parameter part may be removed, and then a white list filtering may be further performed on the extracted information, so that, for example, information in the white list may be excluded. In some embodiments, website address information for famous websites with good creditability can be excluded.

Extracting the trigger action information has been described above. And acquiring attachment information in the mail subject feature will be described as below.

In some embodiments, a step of acquiring attachment information in the mail subject feature may include: determining whether the e-mail contains an attachment.

Some spam mail may have attachments, and the attachments in the spam mail have some common features. Therefore, an attachment in an e-mail can be used as a feature for screening. Thus, detecting and determining the attachment can be performed on the e-mail to be identified, to determine whether the e-mail has the attachment. Details on detecting and determining will be omitted herein.

When the result of determining whether the e-mail contains an attachment is yes, a suffix of the attachment is extracted as the attachment information.

Suffixes of attachments in a same batch of spam mail generally have some common characteristics. For example, the suffixes are generally in a .zip format. Therefore, a suffix of an attachment can be used as a feature, for example, in the attachment information. As the suffixes of the attachments are almost identical or similar, the suffixes of the attachments can be one of features for determining the spam mail. Thus, the attachment information contains a suffix of the attachment.

In addition, sizes of the attachments of the spam mail may also have some common characteristics. For example, in general, sizes of the attachments of the spam mail are similar, and the sizes of the attachments of the spam mail may even be the same. Therefore, the size of the attachment may also be used as a feature for checking and added into the attachment information.

As a result, the attachment information may not only include the suffix of the attachment, but also include other common features or information that attachments of spam mail have. Therefore, common spam-mail attachment features may all be used as the attachment information.

As introduced above, the MIME decoding can be performed on the e-mail to be identified before the mail feature is extracted, to obtain really useful e-mail features and information. After the e-mail is parsed or decoded, the parsed e-mail may be further pre-processed before the mail classification information in the mail feature is acquired.

In some embodiments, the e-mail to be identified is pre-processed. After the e-mail is pre-processed, some noise information and the like in the e-mail can be removed. And character encodings may be unified, and text information of the e-mail can be segmented or normalized, to facilitate standardization of the extracted related information of the e-mail in subsequent steps.

The pre-processing process and the pre-processing manner are as follows: unified character encoding processing, noise removal processing, segmentation processing, normalization processing.

The unified character encoding processing may unify character encoding of the e-mail as encoding in an 8-bit Unicode Transformation Format (UTF-8) format.

The noise removal processing, the segmentation processing and the normalization processing are processes that unify related information in the e-mail, so that information extracted in the subsequent steps is standardized and unified to facilitate processing on feature information.

In some embodiments, the noise removal processing includes removing some meaningless symbols. The meaningless symbols may include meaningless characters inserted into some spam mail intentionally that interfere with spam mail identification. For example, in a sentence “I*(* . . . go to & # Shanghai”, some meaningless symbols are removed by the noise removal processing to finally obtain the sentence “I go to Shanghai”.

The segmentation processing may include segmenting text contents into words that are independent from each other. For example, the sentence “I go to Shanghai” can be divided into three independent set of one or more words: “I”, “go to”, and “Shanghai”.

The normalization processing may generally be performed on word classes. For example, “find” and “found” are unified as “find” by the normalization processing.

Mail subject features extracted from the mail feature of the e-mail to be identified have been introduced above. And a feature string of the mail subject features can be formed after the mail subject feature is extracted and obtained. Thus, the feature string of the mail subject features can be a part of the feature string information corresponding to the mail feature.

Acquiring a mail morphology feature in the mail feature will be introduced as below.

The mail morphology feature also contains many kinds of information. For example, the mail morphology feature contains the following information: mail text type information, mail language information and mail character encoding information.

In some embodiments, the mail morphology feature is acquired by: acquiring mail text type information; acquiring mail language information; and acquiring mail character encoding information.

The text type information includes: a plain text type, an Hyper Text Markup Language (HTML) type, an image type and the like. The image type indicates contents of the e-mail are displayed in images.

The types for the text type information illustrated above are basic and common types for displaying text in the e-mail. Thus, these common types can be used as features of the e-mail to be extracted and obtained.

The mail language information includes many kinds of languages. In some embodiments, general languages may include Chinese, English and so on.

The mail character encoding information generally indicates encoding methods for mail characters. For example, the encoding method may generally include a UTF-8 format or a BIG5 format. The UTF-8 format is a variable length character encoding format for Unicode, and the BIG5 format is a traditional Chinese character encoding format in Taiwan or Hong Kong regions.

In addition to the three kinds of information acquired above, the mail morphology feature may also include mail size information. The mail size information does not need to generate feature string information, but merely exists as a comparison feature in the subsequent steps. Therefore, the mail morphology feature herein also includes mail size information.

Acquiring the mail morphology feature has been introduced above. And extracting a suspected spam mail feature in the mail feature will be introduced and described in the following.

The suspected spam mail feature indicates some common features that the spam mail may have. In a process for collecting spam mail over a long period of time, it can be known that the spam mail may generally have some common or commonly used features. When the common or commonly used feature appears in mail, the mail is preliminarily suspected of being spam mail. Therefore, some common features of the spam mail that have been known are used as the basis for determining whether a certain e-mail is spam mail.

In some embodiments, the step of extracting a mail feature of an e-mail to be identified includes extracting the suspected spam mail feature of the e-mail to be identified.

Correspondingly, the suspected spam mail feature is acquired by: presetting a set of spam mail features.

The feature set is a set of the common features that the spam mail generally has, as mentioned above. And, the above common features of the spam mail are incorporated into a feature set. In the subsequent steps, some features in the e-mail to be identified corresponding to features in the feature set can be extracted.

Whether the e-mail to be identified has a feature identical with that in the set of spam mail features is determined by a mode matching model.

In the step, whether a certain e-mail has a feature corresponding to that in the feature set is mainly determined by a mode matching model. Because features in the feature set are generally common features that pieces of spam mail have, the feature set is used as a basis and reference for extracting the feature in the e-mail to be identified.

When the e-mail to be identified has a feature identical with that in the feature set, the feature can be extracted as the suspected spam mail feature of the e-mail to be identified.

When the e-mail to be identified has a feature identical with that in the feature set, it indicates that the e-mail has a greater chance of being spam mail. Thus, the feature identical with that in the feature set has to be used as the suspected spam mail feature of the e-mail and the spam mail is used as a basis and a reference feature for verifying whether the e-mail to be identified is spam mail.

For example, various kinds of common features in the spam mail include: setting username of “from header” to be identical with or similar to that of “to recipient” in some pieces of spam mail. The above is a common feature of the spam mail.

In addition, the identical feature is generally acquired from: a mail header, main body, and an HTML code level. That is, the mail header, the main body, and the HTML code level usually have common features of spam mail, and the suspected spam mail feature can be obtained most easily from the mail header, the main body, and the HTML code level.

In addition, the mail feature may further include a mail subject matter. Although mail texts of similar spam mail may constantly change, subject changes little. Thus, the mail subject matter can also be used as the mail feature.

Correspondingly, the step of extracting a mail feature of an e-mail to be identified includes: extracting a subject of the e-mail to be identified.

After the subject of the e-mail has been extracted, the subject may be denoised and normalized, to acquire a mail subject matter of the e-mail.

The process of extracting the mail feature by various methods has been described above, and the mail feature is used as a determining basis in the subsequent steps.

In step S102, feature string information is generated from the mail feature, and a mail fingerprint is generated from the feature string information by a preset fingerprint generating method.

The mail feature of the e-mail to be identified has been acquired before step S102. The mail feature includes multiple features, and the multiple features included in the mail feature are collected to generate feature string information. Therefore, each e-mail to be identified may corresponds to its feature string information, and the feature string information indicates some main features of the e-mail to be identified. And the main features are relatively stable. In some embodiments, even if text contents of a certain spam mail are transformed, the mail feature of the spam mail acquired by the above method still can reflect the characteristic of general spam mail that the spam mail has. Therefore, from this perspective, the mail feature extracted in the above step is relatively stable and will not change greatly with the change of the mail text.

Therefore, the generated feature string information may indicate related main features of the e-mail to be identified.

A mail fingerprint is generated from the feature string information by a preset fingerprint generating method, and the preset fingerprint generating method is generally a hash function method.

The hash function is also referred to as a hash in general. Hashing converts an input (pre-mapping) with any length to an output with a fixed length through a hash algorithm. The output is a hash value. The hash function may, for example, include an MD5 hash function.

The feature information may generate the mail fingerprint through the hash function. And the mail fingerprint is a numeric string that can represent an e-mail or one kind of e-mail.

For the mail fingerprint generated by the above method, as the input feature string information is relatively stable feature information and may not change greatly with the change of the form of the e-mail text, the mail fingerprint generated on the basis of the feature string information may be also stable, and the mail fingerprint may be used to determine whether some e-mails have similar features therebetween.

In the following steps, whether mail is similar mail will be determined on the basis of the mail fingerprint and whether mail is spam mail may be further determined according to whether the mail is similar mail.

In step S103, the generated mail fingerprint is compared with an existing fingerprint in a preset mail fingerprint set, and when the mail fingerprint is matched with the existing fingerprint, the count of e-mails having the mail fingerprint is increased.

The preset mail fingerprint set in the step indicates a mail fingerprint set containing corresponding relationships between mail fingerprints and all corresponding e-mails. The mail fingerprint corresponding to each e-mail can be determined through the above step, and the mail fingerprints are made to correspond to the corresponding e-mails.

After collecting and training over a period of time, multiple mail fingerprints and an e-mail corresponding to each of mail fingerprints as well as the number of the e-mails having the identical mail fingerprints may be obtained. Therefore, the existing fingerprint in the preset mail fingerprint set is pre-trained and stored in the mail fingerprint set, the existing fingerprint is used for being compared with the mail fingerprint of the e-mail to be identified.

A comparison manner and determining a comparison result will be illustrated through the following description.

In some embodiments, a step of comparing the generated mail fingerprint with an existing fingerprint in a preset mail fingerprint set, when the mail fingerprint is matched with the existing fingerprint, includes:

determining whether the mail fingerprint is identical with or similar to the existing fingerprint.

In the step, whether there is an existing fingerprint similar to or identical with the generated mail fingerprint is determined from the mail fingerprint set. If the generated mail fingerprint is identical with or similar to a certain existing fingerprint in the mail fingerprint set, it indicates that the generated mail fingerprint has been stored in the mail fingerprint set, and the e-mail corresponding to the fingerprint in the mail fingerprint set has a number of records. If no existing fingerprint similar to or identical with the generated mail fingerprint is determined from the mail fingerprint set, it indicates that the generated mail fingerprint is not matched with the existing fingerprint.

The manner for determining whether the mail fingerprint is identical with or similar to the existing fingerprint in the step may vary according to different mail fingerprint generating methods. In addition, as the mail fingerprint is a set of numeric string, whether the mail fingerprint is identical with or similar to the existing fingerprint can be compared according to whether characters in corresponding positions of two sets of numeric strings being the same.

For example, the mail fingerprint generated by an MD5 function can merely be used to make comparisons in the same manner. Therefore, if a mail fingerprint is generated with the MD5 function, only whether the mail fingerprint set has exactly the same fingerprint may be determined on comparing. However, similar fingerprint sets cannot be determined when the mail fingerprint is compared with the existing fingerprint in the mail fingerprint set.

However, if the mail fingerprint is generated by a simHash function algorithm, whether two groups of fingerprints contain similar features can be determined.

When the result for determining whether the mail fingerprint is identical with or similar to the existing fingerprint is yes, it may be further determined again that whether a difference between a size of the e-mail to be identified and a size of a mail corresponding to the existing fingerprint is less than or equal to a preset difference threshold.

Under normal circumstances, mail sizes of spam mail sent in a same batch are identical or similar. Therefore, a feature of the size of the mail may be determined, so as to more accurately determine whether two pieces of mail are similar. In addition, it is possible that contents are different but fingerprints are identical or similar, even the probability is small. The feature of the size of the mail can be acquired in the process of extracting the mail morphology feature of the e-mail, the extracted mail size information has been introduced in the above step and will not be described in detail herein. It is appreciated that the acquired mail size information can be used as a comparison basis herein.

When the difference between the size of the e-mail to be identified and the size of the mail corresponding to the existing fingerprint is less than or equal to the preset difference threshold, the mail fingerprint is matched with the existing fingerprint.

When the mail fingerprint is identical with or similar to the existing fingerprint and their mail sizes are identical or similar, it indicates that the two e-mails are similar mail and the mail fingerprint is matched with the existing fingerprint.

A method for determining sizes of two e-mails may include presetting a difference threshold, wherein the difference threshold is generally set as +1% or −1%, and the difference between the sizes of the two pieces of mail is no more than 1%. The value is obtained according to experience, and the value may also be set correspondingly according to specific situations.

In addition, when the mail fingerprint is not matched with the existing fingerprint, it indicates that a fingerprint identical with or similar to the mail fingerprint is not recorded in the mail fingerprint set. Therefore, the generated mail fingerprint (and corresponding mail size) is recorded as part of a new fingerprint. Therefore, when the mail fingerprint is not matched with the existing fingerprint, the following step should be performed: adding the mail fingerprint, as a new fingerprint, into the mail fingerprint set.

At first, the generated mail fingerprint is added, as a new fingerprint, into the mail fingerprint set, such that fingerprints in the mail fingerprint set are more abundant and comparing for the subsequently generated mail fingerprints as existing fingerprints are also facilitated in the subsequent e-mail identifying.

After the new fingerprint is added into the mail fingerprint set, the count of e-mails corresponding to the new fingerprint may be increased.

Each fingerprint in the mail fingerprint set has a corresponding number of corresponding e-mails. Therefore, when the new fingerprint is added into the mail fingerprint set, the number of e-mails corresponding to the new fingerprint is recorded. The number of e-mails corresponding to the new fingerprint is counted from 1, and so on.

In step S104, whether the count of e-mails having the mail fingerprint is greater than or equal to a preset threshold is determined, and step S105 is performed when the result is yes.

The step may be discussed respectively according to whether the mail fingerprint is matched with the existing fingerprint.

When the mail fingerprint is matched with the existing fingerprint, it indicates that the mail fingerprint set has the mail fingerprint and the number of e-mails accumulated through the mail fingerprint is also recorded in the mail fingerprint set. Therefore, on the basis of the number of the previous e-mails, the count of e-mails corresponding to the mail fingerprint is increased, and whether the count of e-mails corresponding to the e-mails is greater than or equal to a preset threshold may be determined finally. When it is determined that the number of e-mails corresponding to the mail fingerprint exceeds the preset threshold, it indicates that the e-mails are suspected of being mass spam mail, and the e-mails may be determined as spam mail.

When the mail fingerprint is not matched with the existing fingerprint, the mail fingerprint is stored in the mail fingerprint set as a new fingerprint. Correspondingly, the number of e-mails corresponding to the new fingerprint is recorded, then whether the count of the e-mails corresponding to the new fingerprint is greater than or equal to a preset threshold may be determined. After accumulation over a period of time, the number of e-mails corresponding to the new fingerprint may exceed the preset threshold. In this case, it may also indicate that the e-mails corresponding to the new fingerprint is suspected of being mass spam mail, and the e-mails may also be determined as spam mail.

The preset threshold may be set as 300. The preset threshold is set according to practical experience, and thus the specific value of the preset threshold may be set differently according to actual situations.

In step S105, the e-mail to be identified may be determined as spam mail.

Corresponding contents of the step have been partially introduced in the above step S104. When the result for determining whether the count of e-mails having the mail fingerprint is greater than or equal to a preset threshold is yes, it indicates that the e-mail to be identified is spam mail.

Therefore, in the above method, whether the mail is spam mail is determined by taking the extracted relatively stable mail feature as a basis, rather than merely based on the mail text. Therefore, identifying the spam mail by the above method can better identify and capture the spam mail of the same type whose mail texts continuously change but contents are similar, thus improving accuracy of spam mail identification.

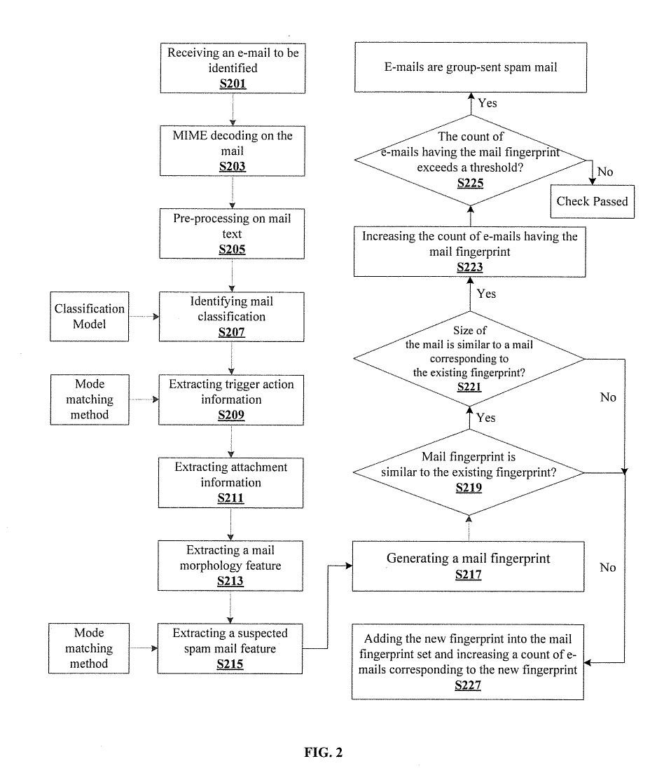

In addition, the method is described in detail according to some embodiments. FIG. 2 is a flow chart of a method for identifying spam mail according to some embodiments of the disclosure.

Referring to FIG. 2, the method for identifying spam mail will be further described as below.

After an e-mail to be identified is received at step S201, the e-mail is MIME decoded at step S203. After decoding, a decoded mail text is subject to a pre-processing operation at step S205 and a process of extracting a mail subject feature following the pre-processing operation.

The process of extracting a mail subject feature may include: identifying a content type of the e-mail by a text classification model or a text classifier at step S207; extracting trigger action information of the e-mail by a mode matching method at step S209; and extracting attachment information of the e-mail at step S211.

Then, a mail morphology feature of the e-mail is extracted at step S213, and a suspected spam mail feature is extracted by a mode matching method at step S215. And the mail subject feature, the mail morphology feature and the suspected spam mail feature that have been extracted are used as mail features to generate feature string information (that is, a feature string text). The feature string text is input into a hash function to calculate and acquire a mail fingerprint at step S217.

After the mail fingerprint is acquired, it is determined whether the mail fingerprint is similar to an existing fingerprint at step S219. If the mail fingerprint is similar to an existing fingerprint, then it is determined whether the size of the mail corresponding to the mail fingerprint is similar to that of the mail corresponding to the existing fingerprint at step S221. When the sizes of the two pieces of mail are similar, the count of mail corresponding to the mail fingerprint is increased at step S223. Then, it is determined that whether the count of e-mails corresponding to the mail fingerprint exceeds a preset threshold at step S225. When the count of e-mails corresponding to the mail fingerprint does not exceed the preset threshold, it indicates that the e-mails are not spam mail and a conclusion is reached that the e-mails pass the check. When the count of e-mails corresponding to the mail fingerprint exceeds the preset threshold, it can be determined that the e-mail to be identified corresponding to the mail fingerprint is a piece of group-sent spam mail.

Correspondingly, when it is determined that the generated mail fingerprint is not similar to the existing fingerprint, or even when the generated mail fingerprint is similar to the existing fingerprint but the mail size corresponding to the mail fingerprint is not close to (or greatly different from) that corresponding to the existing fingerprint, it indicates that the mail fingerprint is not present in the mail fingerprint set. Therefore, the mail fingerprint can be added, as a new fingerprint, to the mail fingerprint set, the count of e-mails corresponding to the new fingerprint is increased correspondingly at step S227, and the mail size of the new fingerprint is maintained at the same time. When the count of e-mails corresponding to the fingerprint does not exceed the preset threshold, it indicates that the e-mails are not spam mail and a conclusion is reached that the e-mails pass the check. When the number of e-mails corresponding to the mail fingerprint exceeds the preset threshold, it can also indicate that the e-mails corresponding to the mail fingerprint are spam mail.

Some embodiments of the disclosure further provide a device for identifying spam mail. The device corresponds to the method provided the embodiments described above.

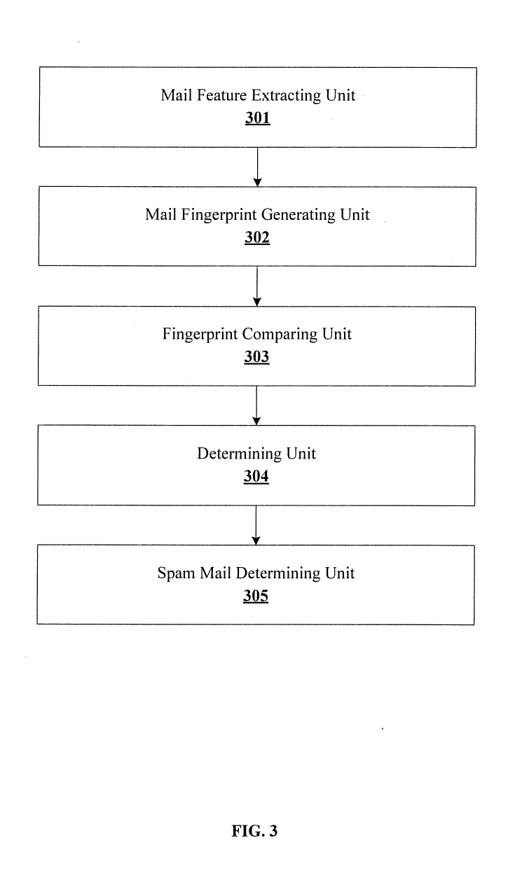

FIG. 3 is a structural schematic diagram of a device for identifying spam mail according to embodiments of the disclosure. The device may include a number of the following units (or sub-units), which are a packaged functional hardware unit designed for use with other components (e.g., portions of an integrated circuit) or a part of a program (stored on a computer readable medium) that performs a particular function of related functions:

a mail feature extracting unit 301, configured to extract a mail feature of an e-mail to be identified, and the mail feature indicates a feature having a stability characteristic extracted from the e-mail;

a mail fingerprint generating unit 302, configured to generate feature string information from the mail feature, and generate a mail fingerprint from the feature string information by a preset fingerprint generating method;

a fingerprint comparing unit 303, configured to compare the generated mail fingerprint with an existing fingerprint in a preset mail fingerprint set, and when the mail fingerprint is matched with the existing fingerprint, a count of e-mails having the mail fingerprint is increased;

a determining unit 304, configured to determine whether the count of e-mails having the mail fingerprint is greater than or equal to a preset threshold; and

a spam mail determining unit 305, configured to determine the e-mail to be identified as spam mail when the result of determining unit 304 is yes.

In some embodiments, the mail feature may include: a mail subject feature, a mail morphology feature, and/or a suspected spam mail feature.

In some embodiments, when the mail feature includes the mail subject feature, mail feature extracting unit 301 may include:

a mail classification information acquiring sub-unit, configured to acquire mail classification information in the mail subject feature; or

a trigger action information acquiring sub-unit, configured to acquire trigger action information in the mail subject feature, the trigger action information indicating information on guiding an action to be further made; or

an attachment information acquiring sub-unit, configured to acquire attachment information in the mail subject feature.

In some embodiments, the device may further include:

a pre-processing unit, configured to pre-process the e-mail to be identified before the mail feature of the e-mail to be identified is extracted.

In some embodiments, the trigger action information acquiring sub-unit may further employ a preset mode matching method to acquire the trigger action information of the mail subject feature.

In some embodiments, the attachment information acquiring sub-unit may include:

an attachment determining sub-unit, configured to determine whether the e-mail contains an attachment;

an attachment information generating sub-unit, configured to extract a suffix of the attachment as the attachment information when a determining result of the attachment determining sub-unit is yes.

In some embodiments, when the mail feature includes the mail morphology feature, the mail feature extracting unit may include:

a text type information acquiring sub-unit, configured to acquire mail text type information;

a language information acquiring sub-unit, configured to acquire mail language information; and

a character encoding information acquiring sub-unit, configured to acquire mail character encoding information.

For example, the text type information may include: a plain text type, an Hyper Text Markup Language (HTML) type, and/or an image type.

In some embodiments, when the mail feature includes the suspected spam mail feature, the mail feature extracting unit may include:

a feature set configuring sub-unit, configured to preset a set of spam mail features;

a common feature determining sub-unit, configured to determine whether the e-mail to be identified has a common feature identical with that in the set of the spam mail features by a mode matching model;

a suspected spam mail information generating sub-unit, configured to, when a determining result of the common feature determining sub-unit is yes, extract the common feature as the suspected spam mail feature of the e-mail to be identified.

In some embodiments, fingerprint comparing unit 303 may include:

a fingerprint determining sub-unit, configured to determine whether the mail fingerprint is identical with or similar to an existing fingerprint;

a mail size determining sub-unit, configured to determine whether a size of the mail corresponding to an existing fingerprint is less than or equal to a preset difference threshold when a determining result of the fingerprint determining sub-unit is yes;

a fingerprint matching sub-unit, configured to, when the difference between the size of the e-mail to be identified and the size of the mail corresponding to the existing fingerprint is less than or equal to the preset difference threshold, match the mail fingerprint with the existing fingerprint.

In some embodiments, when the mail fingerprint is not matched with the existing fingerprint, fingerprint comparing unit 303 may further include:

a new fingerprint generating sub-unit, configured to add the mail fingerprint, as a new fingerprint, into the mail fingerprint set;

a mail counting sub-unit, configured to increase a count of e-mails corresponding to the new fingerprint; and

a mail counting determining sub-unit, configured to determine whether the count of e-mails corresponding to the new fingerprint is greater than or equals to a preset threshold.

In some embodiments, the mail feature may further include a mail subject matter.

Correspondingly, fingerprint comparing unit 303 may include:

a subject extracting sub-unit, configured to extract a subject of the e-mail to be identified;

a subject matter extracting sub-unit, configured to denoise and normalize the subject, so as to acquire a mail subject matter of the e-mail.

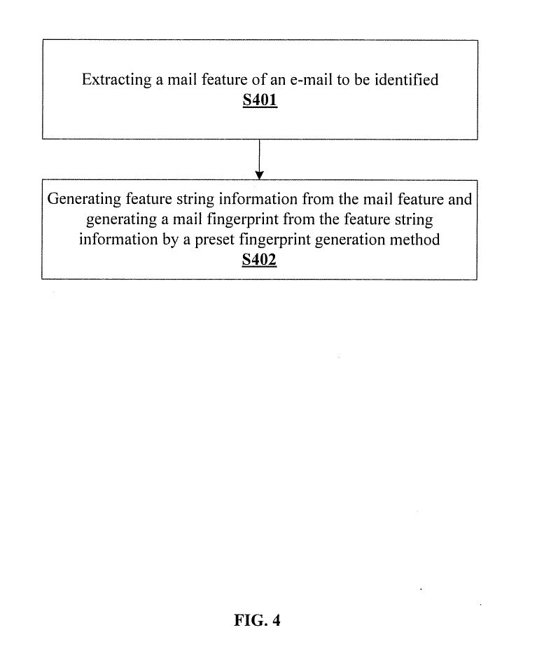

Some embodiments of the disclosure further provide a mail fingerprint generating method for identifying spam mail. FIG. 4 is a flow chart of a mail fingerprint generating method for identifying spam mail, according to some embodiments of the disclosure. The mail fingerprint generating method includes steps S401 and S402 as below.

In step S401, a mail feature of an e-mail to be identified may be extracted. The mail feature indicates a feature having a stability characteristic extracted from the e-mail.

In step S402, feature string information is generated from the mail feature. A mail fingerprint is generated from the feature string information by a preset fingerprint generation method.

In some embodiments, the mail feature includes: a mail subject feature, a mail morphology feature, and/or a suspected spam mail feature.

In some embodiments, when the mail feature includes the mail subject feature, the step of extracting a mail feature of an e-mail to be identified may include extracting the mail subject feature of the e-mail to be identified.

The mail subject feature is acquired by:

acquiring mail classification information in the mail subject feature; or

acquiring trigger action information in the mail subject feature, the trigger action information indicates information on guiding an action to be further made; or

acquiring attachment information in the mail subject feature.

In some embodiments, in the step of acquiring mail classification information in the mail subject feature, the mail classification information may be acquired by:

acquiring a mail content type of the e-mail to be identified by a preset text classifier, and using the mail content type as the mail classification information in the mail subject feature.

In some embodiments, in the step of acquiring a mail content type of the e-mail to be identified by a pre-trained text classifier, the text classifier includes: a naive Bayes text classifier, a text classifier supported by a vector algorithm, or a text classifier based on a minimum approach.

In some embodiments, in the step of acquiring mail classification information in the mail subject feature, the mail classification information may be acquired by:

acquiring a core text from the mail contents of the e-mail to be identified by a preset text filtering method;

training the core text through an off-line database;

determining whether the trained core text meets a new classification feature generating condition; and

if the trained core text meets a new classification feature generating condition, using the core text as the mail classification information in the mail subject feature.

In some embodiments, the trigger action information in the step of acquiring trigger action information in the mail subject feature includes: a replied mail address, a phone number, a contact for a social software, bank card information, company information, and/or a webpage link symbol.

In some embodiments, when the trigger action information is the webpage link symbol, after the step of acquiring mail classification information in the mail subject feature, the following steps are performed:

determining whether a website address corresponding to the webpage link symbol is a full website address;

if the website address corresponding to the webpage link symbol is a full website address, removing a parameter part in the website address, and recording a new generated website address as a retained website address set;

if the website address corresponding to the webpage link symbol is not a full website address, determining whether the website address is a short website address;

when the website address is the short website address, recording, address as the retained website address set, a new website generated by retaining a domain name part of the website;

matching website address in the retained website address set with a preset white list, removing website address having the same information in the retained website address set as in the white list, to generate a new retained website address set; and

using the new retained website address set as an additional webpage link symbol.

In some embodiments, the step of acquiring trigger action information in the mail subject feature includes:

acquiring the trigger action information in the mail subject feature by a preset mode matching method.

In some embodiments, the step of acquiring attachment information in the mail subject feature includes:

determining whether the e-mail contains an attachment; and

if the e-mail contains an attachment, extracting a suffix of the attachment as the attachment information.

In some embodiments, when the mail feature includes the mail morphology feature, the step of extracting a mail feature of an e-mail to be identified includes extracting the mail morphology feature of the e-mail to be identified.

The mail morphology feature may be acquired by:

acquiring mail text type information;

acquiring mail language information; and

acquiring mail character encoding information.

The text type information includes: a plain text type, an HTML type, and/or an image type.

In some embodiments, when the mail feature is the suspected spam mail feature, the step of extracting a mail feature of an e-mail to be identified may include extracting the suspected spam mail feature of the e-mail to be identified.

The suspected spam mail feature may be acquired by:

presetting a set of spam mail features;

determining, by a mode matching model, whether the e-mail to be identified has a feature identical with that in the set of spam mail features; and

if the e-mail to be identified has a feature identical with that in the set of spam mail features, extracting the identical feature as the suspected spam mail feature of the e-mail to be identified.

In some embodiments, in the step of generating a mail fingerprint from the feature string information by a preset fingerprint generation method, the preset fingerprint generating method includes a hash function method.

The mail fingerprint generation method is corresponding to the mail fingerprint generation method in the embodiments described above, and thus reference can be made to the above embodiments of the disclosure for the mail fingerprint generation method described herein.

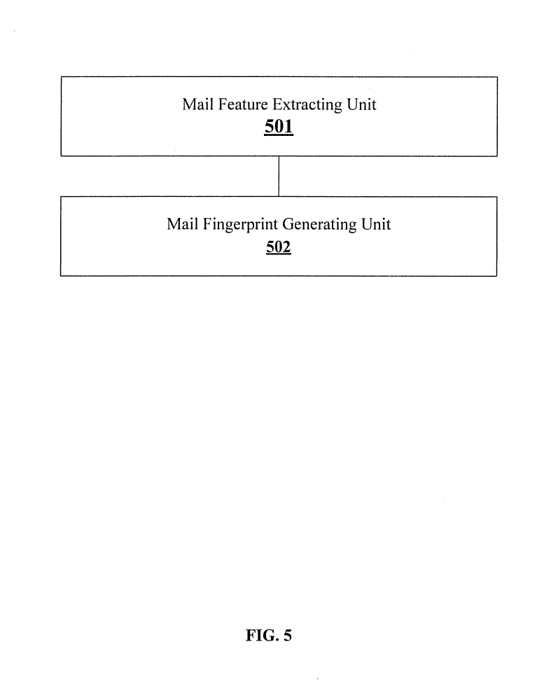

Some embodiments of the disclosure further provide a mail fingerprint generating device for identifying spam mail. FIG. 5 is a structural schematic diagram of a mail fingerprint generating device for identifying spam mail according to embodiments of the disclosure. Referring to FIG. 5, the mail fingerprint generating device includes a mail feature extracting unit 501 and a mail fingerprint generating unit 502, as further described below.

Mail feature extracting unit 501 may be configured to extract a mail feature of an e-mail to be identified. The mail feature may include a mail subject feature, a mail morphology feature, and/or a suspected spam mail feature.

Mail fingerprint generating unit 502 may be configured to generate feature string information from the mail feature, and generate a mail fingerprint from the feature string information by a preset fingerprint generation method.

Embodiments of the disclosure have been provided as above. However, the disclosure is not limited by the above embodiments. It should be understood by those skilled in the art that various changes and modifications may be made without departing from the spirit and scope of the disclosure, and therefore the scope of the disclosure should be defined by the claims of the disclosure.

In a general configuration, a computing device may include one or more processors (CPU), an input/output interface (I/O), a network interface, and a memory.

The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage may be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

It is appreciated that embodiments of the disclosure may be provided as a method, a system and/or a computer program product. Therefore, the embodiments may be implemented in a form of hardware, software or a combination thereof. And, the embodiments may be in a form of a computer program product implemented on a computer readable storage medium containing computer readable program codes (including but not limited to a disk, a CD-ROM, an optical storage, and the like).

What is claimed is:

1. A method for identifying spam mail, comprising:
extracting a mail feature of an e-mail to be identified, the mail feature indicating a feature having a stability characteristic extracted from the e-mail;
generating feature string information from the mail feature;
generating a mail fingerprint from the feature string information;
comparing the generated mail fingerprint with an existing fingerprint in a preset mail fingerprint set,
responsive to the comparison indicating that the mail fingerprint corresponds with the existing fingerprint, increasing a count of e-mails having the mail fingerprint;
determining whether the count of e-mails having the mail fingerprint is greater than or equal to a preset threshold; and
responsive to the count of e-mails having the mail fingerprint is greater than or equal to a preset threshold, determining the e-mail to be spam mail.

2. The method according to claim 1, wherein the mail feature comprises a mail subject feature, a mail morphology feature, and/or a suspected spam mail feature.

3. The method according to claim 2, wherein when the mail feature comprises the mail subject feature, extracting a mail feature of an e-mail to be identified further comprises:
extracting the mail subject feature of the e-mail to be identified;
the mail subject feature is extracted by at least one of:
acquiring mail classification information in the mail subject feature;
acquiring trigger action information in the mail subject feature, the trigger action information indicating information on guiding an action to be further made; or
acquiring attachment information in the mail subject feature.

4. The method according to claim 3, wherein acquiring mail classification information in the mail subject feature further comprises:
acquiring a mail content type of the e-mail to be identified by a preset text classifier, and
using the mail content type as the mail classification information in the mail subject feature.

5. The method according to claim 4, wherein before acquiring a mail content type of the e-mail to be identified by a preset text classifier, the method further comprises:
pre-processing the e-mail to be identified,
wherein the pre-processing comprises at least one of:
unified character encoding processing, noise removal processing, segmentation processing, and normalization processing.

6. The method according to claim 3, wherein the trigger action information comprises:
a replied mail address, a phone number, a contact for a social software, bank card information, company information, and/or a webpage link symbol.

7. The method according to claim 6, wherein when the trigger action information comprises the webpage link symbol, after acquiring mail classification information in the mail subject feature, the method further comprises:
determining whether a website address corresponding to the webpage link symbol is a full website address;
in response to the website address corresponding to the webpage link symbol being a normal website address:
removing a parameter part in the website address, and
recording a new generated website address in a retained website address set;
in response to the website address corresponding to the webpage link symbol being not a normal website address:
determining whether the website address is a short website address;
in response to the website address being the short website address, recording a new website generated by retaining a domain name part of the website address in the retained website address set.

8. The method according to claim 7, wherein the method further comprises:
matching website addresses in the retained website address set with a preset white list;
removing website addresses having the same information in the retained website address set as in the white list, to generate a new retained website address set; and
using the new retained website address set as an additional webpage link symbol.

9. The method according to claim 3, wherein acquiring trigger action information in the mail subject feature comprises:
acquiring the trigger action information in the mail subject feature by a preset mode matching method.

10. The method according to claim 3, wherein acquiring attachment information in the mail subject feature comprises:
determining whether the e-mail contains an attachment;
in response to the determination that the e-mail contains an attachment, extracting a suffix of the attachment as the attachment information.

11. The method according to claim 2, wherein when the mail feature comprises the mail morphology feature, extracting a mail feature of an e-mail to be identified further comprises:
extracting the mail morphology feature of the e-mail to be identified, wherein
the mail morphology feature is extracted by acquiring mail text type information, acquiring mail language information, and acquiring mail character encoding information, wherein
the mail text type information comprises: a plain text type, an HTML type, and/or an image type.

12. The method according to claim 2, wherein when the mail feature comprises the suspected spam mail feature, extracting a mail feature of an e-mail to be identified further comprises:
extracting the suspected spam mail feature of the e-mail to be identified, wherein the suspected spam mail feature is acquired by:
presetting a set of spam mail features;
determining, by a mode matching model, whether the e-mail to be identified has a feature identical with that in the set of spam mail features;
in response to the determination that the e-mail to be identified has the feature identical with that in the set of spam mail features, extracting the identical feature as the suspected spam mail feature of the e-mail to be identified.

13. The method according to claim 12, wherein determining, by a mode matching model, whether the e-mail to be identified has a feature identical with that in the feature set of the spam mail further comprises:
acquiring the feature from a mail header, main body, and/or a Hyper Text Markup Language (HTML) code level.

14. The method according to claim 1, wherein comparing the generated mail fingerprint with an existing fingerprint in a preset mail fingerprint set, responsive to the comparison indicating that the mail fingerprint corresponds with the existing fingerprint, increasing a count of e-mails having the mail fingerprint further comprises:
determining whether the mail fingerprint is identical with or similar to the existing fingerprint;
in response to the determination that the mail fingerprint is identical with or similar to the existing fingerprint, determining whether a difference between a size of the e-mail to be identified and a size of a mail corresponding to the existing fingerprint is less than or equal to a preset difference threshold;
in response to the determination that the difference between the size of the e-mail to be identified and the size of the mail corresponding to the existing fingerprint is less than or equal to the preset difference threshold, the mail fingerprint is matched with the existing fingerprint.

15. The method according to claim 1, wherein when the mail fingerprint does not correspond with the existing fingerprint, the method further comprises:
adding the mail fingerprint, as a new fingerprint, into the mail fingerprint set;
increasing the count of e-mails corresponding to the new fingerprint;
determining whether the count of e-mails having the mail fingerprint is greater than or equal to a preset threshold further comprises:
determining whether the count of e-mails corresponding to the new fingerprint is greater than or equal to the preset threshold.

16. The method according to claim 1, wherein
the mail feature further comprises a mail subject matter;
extracting a mail feature of an e-mail to be identified comprises:
extracting a subject of the e-mail to be identified;
performing noise removal and normalization processing on the subject to acquire the mail subject matter of the e-mail.

17. The method according to claim 1, wherein before extracting a mail feature of an e-mail to be identified, the method further comprises:
decoding the e-mail to be identified to acquire use identification information of the e-mail to be identified.

18. A mail fingerprint generating method for identifying spam mail, comprising:
extracting a mail feature of an e-mail to be identified, the mail feature indicating a feature having a stability characteristic extracted from the e-mail;
generating feature string information from the mail feature; and
generating a mail fingerprint from the feature string information.

19. A non-transitory computer readable medium that stores a set of instructions that is executable by at least one processor of an electronic device to cause the electronic device to perform a method for identifying spam mail, the method comprising:
extracting a mail feature of an e-mail to be identified, the mail feature indicating a feature having a stability characteristic extracted from the e-mail;
generating feature string information from the mail feature;
generating a mail fingerprint from the feature string information;
comparing the generated mail fingerprint with an existing fingerprint in a preset mail fingerprint set;
responsive to the comparison indicating that the mail fingerprint corresponds with the existing fingerprint, increasing a count of e-mails having the mail fingerprint;
determining whether the count of e-mails having the mail fingerprint is greater than or equal to a preset threshold; and
responsive to the count of e-mails having the mail fingerprint is greater than or equal to a preset threshold, determining the e-mail to be identified as a spam mail.

20. A non-transitory computer readable medium that stores a set of instructions that is executable by at least one processor of an electronic device to cause the electronic device to perform a mail fingerprint generating method for identifying spam mail, the method comprising:
extracting a mail feature of an e-mail to be identified, the mail feature indicating a feature having a stability characteristic extracted from the e-mail;
generating feature string information from the mail feature; and
generating a mail fingerprint from the feature string information.
